(19) United States
(12) Patent Application Publication
(10) Pub. No.: US 2024/0219856 A1
(43) Pub. Date: Jul. 4, 2024

(54) IMAGE FORMING SYSTEM AND IMAGE FORMING METHOD

(71) Applicant: Konica Minolta, Inc., Tokyo (JP)

(72) Inventor: Kazuhiko NAKAJIMA, Tokyo (JP)

(21) Appl. No.: 18/537,017

(22) Filed: Dec. 12, 2023

(30) Foreign Application Priority Data
Dec. 23, 2022 (JP) 2022-206748
May 10, 2023 (JP) 2023-077540

(51) Int. Cl. G03G 9/09; G03G 9/08; G03G 9/097

(52) U.S. Cl. CPC G03G 9/0926; G03G 9/0819; G03G 9/0902; G03G 9/09725; G03G 2215/0409

(57) ABSTRACT

An image forming system that forms an image on a continuous sheet using an electrostatic charge image development toner. The electrostatic charge image development toner includes a toner base particle including a binder resin and a brilliant pigment having a coating layer containing an inorganic element.

### CROSS-REFERENCE TO RELATED APPLICATIONS

The entire disclosure of Japanese Patent Application No. 2022-206748 filed on Dec. 23, 2022 and Japanese Patent Application No. 2023-077540 filed on May 10, 2023 is incorporated herein by reference in its entirety.

### BACKGROUND

### Technical Field

The present invention relates to an image forming system and an image forming method. More specifically, the present invention relates to an image forming system and the like capable of preventing image defects such as streak unevenness by reducing damage to a fixing member during image formation.

### Description of Related Art

In recent years, with the spread and improvement in performance of image forming apparatuses such as color printers for forming color images, there has been developed a brilliant toner (i.e., a brilliant developer) to be used for forming a brilliant image such as a gold or silver image on a recording medium by utilizing an electrophotographic method.

For example, in JP 2018-205335 A, charging defects are prevented by controlling the degree of hydrophobicity of the brilliant pigments, and the problem of image defects is prevented by suppressing the occurrence of fogging.

However, it has been found that in the case of printing on continuous sheet, image failure in the use of the brilliant pigment becomes a problem.

### SUMMARY

The present invention has been made in view of the above-described problems and circumstances, and an object of the present invention is to provide an image forming system and an image forming method capable of preventing image defects such as streak unevenness by reducing scratches on a fixing member during image formation.

In order to solve the problem, the present inventor has studied the causes of the problems and the like, and as a result, have found that the problem can be solved by covering a brilliant pigment contained in toner base particles included in an electrostatic charge image development toner with a coating layer containing an inorganic element, and have completed the present invention. That is, the above-described problems according to the present invention may be solved by the following.

To achieve at least one of the abovementioned objects, according to an aspect of the present invention, the image forming system reflecting one aspect of the present invention is an image forming system that forms an image on a continuous sheet using an electrostatic charge image development toner, wherein
the electrostatic charge image development toner includes a toner base particle including a binder resin and a brilliant pigment having a coating layer containing an inorganic element.

To achieve at least one of the abovementioned objects, according to another aspect of the present invention, an image forming method reflecting one aspect of the present invention is an image forming method for forming an image on a continuous sheet using an electrostatic charge image development toner, wherein
the electrostatic charge image development toner includes a toner base particle including a binder resin and a brilliant pigment having a coating layer containing an inorganic element.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a conceptual diagram showing the influence of a brilliant pigment having no coating layer on a fixing member;

FIG. 2 is a conceptual diagram showing the influence of the brilliant pigment having the coating layer on the fixing member;

FIG. 3 is an example illustrating the appearance of a brilliant pigment having a coating layer according to the present invention;

FIG. 4 is a conceptual diagram illustrating the effect of an external additive on a fixing member;

FIG. 5 is an example of a conceptual diagram of a sheet passing state of a cut sheet and a continuous sheet during continuous printing;

FIG. 6 is a conceptual diagram illustrating a relationship between time and a change in the surface temperature of the fixing member in a sheet passing state of a continuous sheet and a cut sheet during continuous printing;

FIG. 7 is a simplified view of an example of a fixing member according to the present invention; and

FIG. 8 is a diagram illustrating an example of a configuration of an image forming apparatus used at the time of image formation.

### DETAILED DESCRIPTION

A feature of the image forming system of the present invention is that the image forming system is an image forming system that forms an image on continuous sheet using an electrostatic charge image development toner, and the electrostatic charge image development toner contains toner base particles including a binder resin and a brilliant pigment having a coating layer containing an inorganic element. This feature is a technical feature common to or corresponding to the following embodiments (aspects).

Further, an image forming method of the present invention is an image forming method for forming an image on continuous sheet by using an electrostatic charge image development toner, wherein the electrostatic charge image development toner includes toner base particles including a binder resin and a brilliant pigment having a coating layer containing an inorganic element.

As an embodiment of the present invention, it is preferable that the thickness of the coating layer is in a range of 0.01 to 0.50 μm from the viewpoint of improving the charging property and suppressing scratches on the fixing member.

The particle diameter of the external additive added to the toner base particles is preferably in the range of 20 to 300 μm from the viewpoint of stabilization of the charging amount and suppression of scratches on the fixing member.

It is preferable that the aspect ratio of the brilliant pigment is in a range of 3 to 100 from the viewpoint of the brilliant feeling and the mechanical strength.

The brilliant pigment is preferably aluminum from the viewpoint of weather resistance, lightness in specific gravity, availability, and the like.

The coating layer preferably contains a silicon-containing compound from the viewpoint of chemical stability and brilliance.

In addition, even when the image forming system or the image forming method includes an LED light source as the exposure section, the light source does not become dark and is suitable, which is preferable.

Hereinafter, the present invention, constituent elements thereof, and embodiments and aspects for carrying out the present invention will be described in detail. In the present application, “to” is used to mean that numerical values described before and after “to” are included as a lower limit value and an upper limit value. However, the scope of the invention is not limited to the disclosed embodiments.

### [Image Forming System]

An image forming system according to an aspect of the present invention is an image forming system for forming an image on continuous sheet using an electrostatic charge image development toner, wherein the electrostatic charge image development toner includes toner base particles containing binder resin and a brilliant pigment having a coating layer containing an inorganic element.

### 1. Electrostatic Charge Image Development Toner

An electrostatic charge image development toner according to an aspect of the present invention includes toner base particles containing binder resin and a brilliant pigment having a coating layer containing an inorganic element.

### (1.1) Toner Base Particles

A toner base particles according to an aspect of the present invention at least partially contain a brilliant pigment as a pigment, and the brilliant pigment has a coating layer containing an inorganic element.

The toner base particles according to an aspect of the present invention may contain, in addition to the brilliant pigment as described above, other components such as an external additive, a binder resin, a release agent, a charge control agent, a pigment other than the brilliant pigment, and a colorant other than the pigment.

Here, the term “toner particles” refers to toner base particles to which an external additive is added, and an aggregate of toner particles is referred to as a “toner”.

In general, the toner base particles can be used as toner particles as they are, but here, toner particles obtained by adding an external additive to the toner base particles are used as toner particles.

Furthermore, in the following description, the toner base particles and the toner particles are also simply referred to as “toner particles” when there is no particular needs to distinguish between them.

Next, details of each constituent material of the toner base particle according to an aspect of the present invention will be described.

### (1.2) Brilliant Pigment

The brilliant pigment according to an aspect of the present invention (hereinafter, also referred to as “brilliant pigment particles”) contains metal particles and has a coating layer containing and an inorganic element. Hereinafter, a portion of the brilliant pigment which is covered with the coating layer and does not include the coating layer, that is, a brilliant material (metal particle) which is a portion serving as a material of the brilliant pigment having the coating layer of an aspect of the present invention is also referred to as a “core particle”.

In addition to the above-described brilliant material (metal particles), as the material of the brilliant pigment having a coating layer of an aspect of the present invention, in addition to the above-described brilliant material, conventionally known materials can be used without particular limitation, and for example, an inorganic pigment, an organic pigment, an insoluble pigment, and the like can be used.

The metal particle (core particle) is not particularly limited, and for example, any metal used as a known or commercially available metal pigment, such as aluminum, an aluminum alloy, copper, silver, tin, chromium, and stainless steel, can be used. The metal includes not only a metal simple substance but also an alloy and an intermetallic compound.

In addition, the brilliant material is not necessarily composed of only a metal, and as long as the effect of the present invention is exhibited, for example, particles obtained by coating, with a metal, the surface of inorganic particles such as mica and glass, and particles of a synthetic resin are also included. In particular, particles made of aluminum or an aluminum alloy are desirable from the viewpoints of weather resistance, lightness in specific gravity, availability, and the like.

The average particle diameter of the core particles of the brilliant pigment may be set such that, for example, the volume average particle diameter (D₅₀) in a case where the volume distribution is measured by a laser diffraction type particle size distribution meter is in a range of 0.1 to 50 μm.

The aspect ratio of the core particle of the brilliant pigment is preferably in the range of 3 to 100. The control of the shape having a desired aspect ratio slightly varies depending on the metal type of the core particle of the brilliant pigment, but can be generally performed by adjusting the mixing of raw materials, pH, and sintering temperature.

For example, in the case of titanium oxide (TiO₂), adjustment of the ratio of an alkali metal salt to a titanium source (preparation of raw materials), the pH, and the firing temperature is effective in obtaining a shape having a desired aspect ratio. In the case of ZnO, adjustment of the molar ratio of hydroxide ion/zinc ion and pH is effective for obtaining a shape having a desired aspect ratio. In the case of SnO₂, adjustment of the mixing ratio of the silicon compound and the tin compound and the firing temperature is effective in obtaining a shape having a desired aspect ratio.

In the case of the composite metal oxide particles, the shape of the core material may be controlled in order to cause other metal oxide particles to adhere to the core material (metal oxide particles).

### (Aspect Ratio)

Here, the “aspect ratio” refers to a ratio (W/H) of a short axis particle diameter W to a thickness H when a maximum length in the core particle of the brilliant pigment is a long axis particle diameter L, a maximum length in a direction intersecting the long axis particle diameter L is a short axis particle diameter W, and a minimum length in a direction orthogonal to the long axis particle diameter L is a thickness H.

The average thickness of the core particles of the brilliant pigment is an average value of thicknesses measured for arbitrarily selected 100 core particles of the brilliant pigment, and the average long axis particle diameter of the core particles of the brilliant pigment is an average value of long axis particle diameters measured for arbitrarily selected 100 core particles of the brilliant pigment.

In addition, the thickness and particle diameter (including long axis particle diameter and short axis particle diameter) of the core particle of each brilliant pigment are measured as follows. First, the core particles of the brilliant pigments are sprinkled and fixed on a double-sided tape, and the surfaces thereof are observed with a microscope VHX-6000 at a magnification at which the shapes of the core particles of the brilliant pigments can be confirmed. Then, the observed image is binarized by LUSEX-AP manufactured by Nireco Corporation, and the long-axis particle diameter L, the short-axis particle diameter W, and the height H of 100 arbitrary powder particles are measured, and the average values thereof are adopted.

The measurement and calculation of the aspect ratio of the core particle of the brilliant pigment are performed on the metal or metal oxide particle before the surface treatment, and do not include the metal or metal oxide particle after the surface treatment.

In a case where the aspect ratio is 3 or more, the brilliant feeling is not insufficient, and in a case where the aspect ratio is 100 or less, a case where the mechanical strength is decreased and the color tone becomes unstable is eliminated.

The shape of the brilliant pigment is not limited, but is particularly preferably a scaly shape (a flake shape), and thus, high hiding power and the like can be obtained.

### (Coating Layer Containing an Inorganic Element)

The thickness of the coating layer containing an inorganic element included in the brilliant pigment according to an aspect of the present invention is preferably in a range of 0.01 to 0.50 μm from the viewpoint of improving the charging property and suppressing scratches on the fixing member. The thickness of the coating layer was determined as follows. First, the scaly shape pigments are horizontally held on a certain substrate, and cross-sectional slices of the pigments are prepared using a focused ion beam processing apparatus (JIB-4000PLUS, manufactured by JEOL Ltd). Next, an image was taken with a transmission electron microscope (JEM, 2010F, manufactured by JEOL Corporation) at a magnification of 10,000 times, and the thickness was determined using a compact general-purpose image processing and analysis system (Roux Seck (R) AP, manufactured by Nireco Corporation).

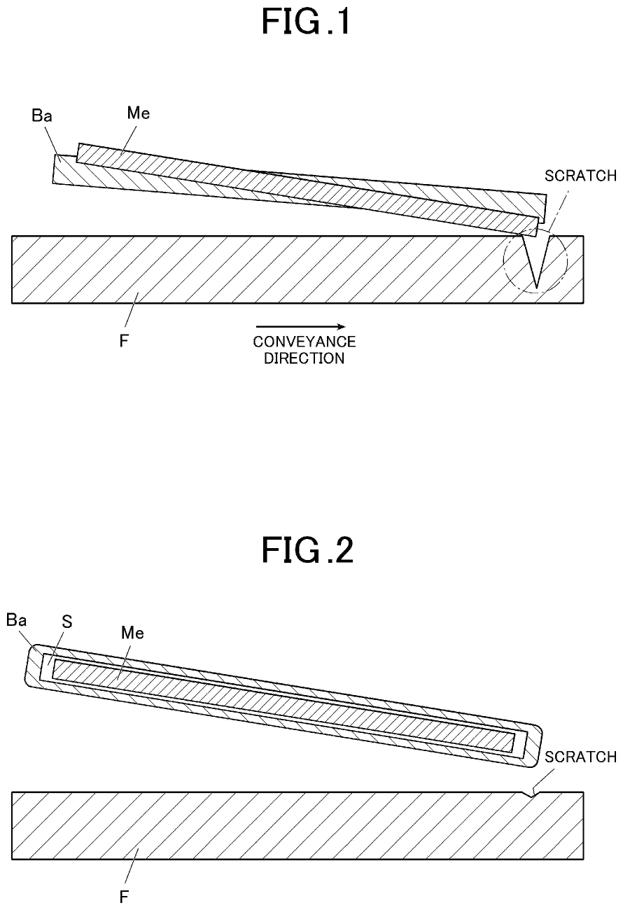

FIG. 1 is a conceptual diagram showing the influence of a brilliant pigment having no coating layer on a fixing member. The binder resin Ba that is a main component of the toner particle is relatively soft. When the brilliant material Me is used as it is as the brilliant pigment having no coating layer, since the brilliant material Me has a horizontally long plate-like shape, a part of the brilliant material Me protrudes outward from the surface layer of the binder resin Ba surrounding the brilliant material Me as shown in FIG. 1. That is, the surface of the fixing member F is scratched by the exposure. In order to solve such a problem, in an aspect of the present invention, the brilliant material Me is covered with a coating layer containing an inorganic element to obtain a brilliant pigment having a coating layer. The binder resin Ba which is a main component of the toner particle is not included in the constituent components of the coating layer which is a part of the brilliant pigment according to an aspect of the present invention.

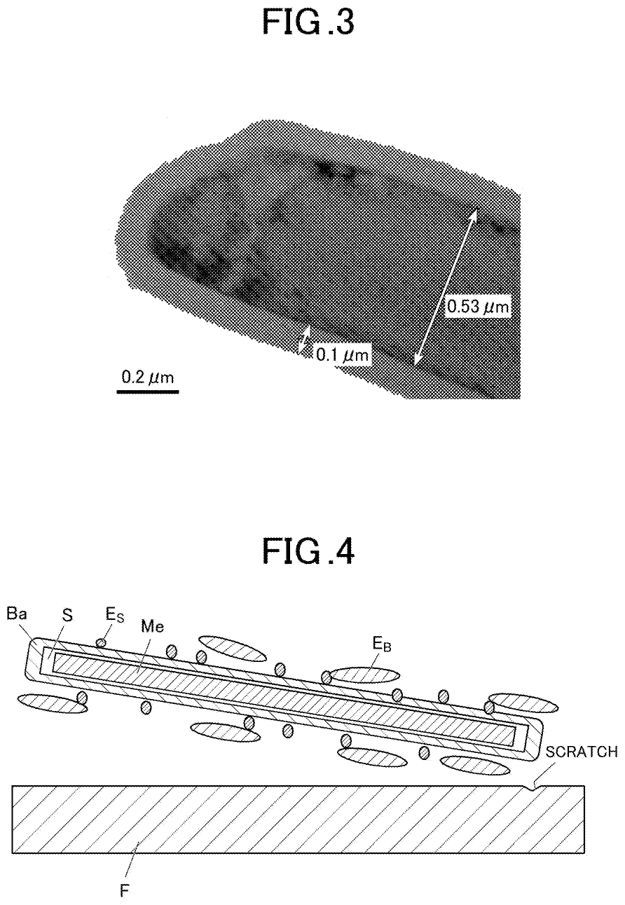

FIG. 2 is a conceptual diagram showing the influence of the brilliant pigment having the coating layer on the fixing member. In addition, FIG. 3 is an example showing a state of the brilliant pigment having the coating layer according to an aspect of the present invention actually observed by an electron microscope when aluminum is used as the brilliant material and is covered with the coating layer.

As shown in FIG. 2, since the brilliant material Me is covered with the coating layer S containing an inorganic element, a part of the brilliant material Me is not exposed from the surface layer of the binder resin Ba which is a main component of the toner particle. This can prevent the end portions of the exposed scale-like brilliant material Me from damaging the fixing member F, thereby suppressing image failure such as streak unevenness.

Since the coating layer containing an inorganic element contains an inorganic element, the coating layer is harder than the binder resin and does not easily expose the metal therein. A preferable stem element is silicon, and it is preferable to contain a silicon-containing compound from the viewpoint of chemical stability and brilliance. The coating layer is preferably a layer composed of a compound containing a siloxane bond (Si—O bond) (hereinafter, also referred to as “Si—O-based coating layer”). Examples of the stem element other than silicon include titanium, zirconium, and iron. Examples of compounds other than the silicon-containing compound that the coating layer contains include metal oxides such as titanium oxide, zirconium oxide, and iron oxide.

Examples of the silicon-containing compound contained in the coating layer according to an aspect of the present invention include a silane-based compound and a silicon oxide. That is, specific examples include silicon oxides represented by SiO₂, SiO₂·nH₂O (where n represents any positive integer) and the like in addition to the silane-based compound [H₃SiO (H₂SiO)nSiH₃] (where n represents any positive integer).

These compounds may be either crystalline or amorphous, but are particularly preferably amorphous. Therefore, as the layer containing a silicon oxide (silica or the like), for example, a layer containing amorphous silica can also be suitably adopted as the coating layer containing an inorganic element according to an aspect of the present invention.

Furthermore, a layer formed using, for example, an organosilicon compound (including a silane coupling agent) as a starting material can also be adopted as the Si—O based coating layer. Therefore, the silicon compound-containing layer may contain an organosilicon compound or a derived component thereof within a range that does not impair the effects of the present invention.

In addition, the silicon compound-containing layer does not needs to be a coating layer composed of only a silicon compound, and may contain additives, impurities, and the like other than the silicon compound within a range not impairing the characteristics of the present invention.

Here, the content of the inorganic element is not particularly limited, but is preferably in a range of 1 to 20 parts by mass, and more preferably in a range of 2 to 15 parts by mass with respect to 100 parts by mass of the brilliant pigment. In a case where the silicon content is 1 part by mass or more, there is a tendency that corrosion resistance, water dispersibility, stability, and the like do not deteriorate. When the content of silicon is 20 parts by mass or less, the aluminum pigment does not aggregate, the concealing property does not deteriorate, and the color tone such as metallic luster is not impaired.

The surface of the coating layer containing the inorganic element is preferably hydrophilic, and in this case, the brilliant pigment can be highly dispersed in an aqueous solvent (water or a mixed solvent containing water and an organic solvent). In particular, since silicon oxide (amorphous silica or the like) is very stable in an aqueous solvent, it is possible to provide a pigment which is very stable in an aqueous solvent.

In a case where the thickness of the coating layer containing an inorganic element is sufficient, water resistance becomes sufficient, and corrosion or discoloration of the metal particle in the water-based paint does not occur. On the other hand, when the coating layer containing an inorganic element is not too thick, the above-described disorder of the orientation due to the overlapping of the metal particles does not occur, and the brightness does not decrease.

In addition, when the metal particles can be highly independently dispersed, a decrease in sharpness due to an increase in the surface roughness of the coating layer containing an inorganic element does not occur. Furthermore, it is possible to suppress a decrease in hiding power due to a decrease in the ratio of metal particles per unit mass.

The coating ratio of the coating layer containing an inorganic element (hereinafter, also simply referred to as “coating ratio”) represents an occupied area ratio (%) of the coating layer with respect to the area of the surface of one core particle of the brilliant pigment in a photographic image of a scanning electron microscope (SEM). When the coating ratio is 70% or more, the core particle of the brilliant pigment hardly penetrates through the coating layer, and even when the core particle penetrates through the coating layer, the corner is covered, and thus the fixing member is not damaged.

The calculation of “coating ratio” can be performed as follows.

Regarding the brilliant pigment, 100 brilliant pigment particles are randomly imaged in a visual field magnified at a maximum of 40,000 times using a scanning electron microscope (SEM; for example, “JSM-7401F” (manufactured by JEOL Ltd)). The area “A” of the region not covered with the coating layer and the area “B” of the region covered with the coating layer in the brilliant pigment particles are measured from the captured image, and the proportion [B/(A+B)] of the region covered with the coating layer is calculated.

The coating ratio was measured for 100 brilliant pigment particles, and the arithmetic average value thereof was defined as the coating ratio.

The coating ratio can be controlled by increasing or decreasing the amount of the material to coat and changing the treatment conditions, for example, the stirring Reynolds number.

### (1.3) External Additive

The external additive may include particles containing an inorganic material as a main component, such as alumina particles, silica particles, strontium titanate particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles.

The particles containing any of these inorganic materials as a main component may be subjected to a hydrophobic treatment with a surface treating agent such as a silane coupling agent or a silicone oil, if necessary. The external additive may contain particles containing, as a main component, an organic material containing a homopolymer such as styrene or methyl methacrylate or a copolymer thereof. Further, the external additive may contain a lubricant such as a metal salt of a higher fatty acid.

Examples of the metal salts of higher fatty acids include stearic acid, oleic acid, palmitic acid, linoleic acid, and ricinoleic acid. Examples of metals constituting the metal salt include zinc, manganese, aluminum, iron, copper, magnesium, calcium, and the like.

The content of these external additives is preferably in the range of 0.05 to 5.0 mass % with respect to the total mass of the toner base particles, and more preferably 0.3 mass % or less.

The particle diameter of the external additive added to the toner base particles, that is, the number average particle diameter, is preferably in the range of 20 to 300 μm from the viewpoint of stabilization of the charging amount and suppression of damage to the fixing member. When the particle diameter is 20 μm or more, it is possible to prevent a corner of the brilliant pigment from directly coming into contact with the fixing roller. In addition, when the particle diameter is 300 μm or less, the fluidity of the toner is improved, and the external additive is easily transferred from the toner particle to the carrier particle, and in particular, it is possible to stabilize the charging amount fluctuation at the time of high coverage printing.

FIG. 4 is a conceptual diagram illustrating the effect of an external additive on a fixing member. Although the large-diameter external additive E_{B} and the small-diameter external additive E_{S} are mixed in FIG. 4, the presence of the large-diameter external additive E_{B} in addition to the coating layer S containing inorganic elements according to an aspect of the present invention can prevent the corners of the brilliant material Me from directly contacting the fixing member F. Thus, the effect of suppressing damage to the fixing member F is enhanced.

The “large-diameter external additive” refers to an external additive having a particle diameter of 20 μm or more. The term “small-diameter external additive” refers to an external additive having a particle diameter of less than 20 μm.

The number average particle diameter of the external additive externally added to the electrostatic charge image development toner according to an aspect of the present invention is specifically measured by the following method.

A 30,000-fold photograph of the toner is taken with a scanning electron microscope, and this photographic image is captured by a scanner. Using an image processing and analyzing apparatus LUZEX AP (manufactured by Nireco Corporation), the external additive present on the toner surface of the aforementioned photographic image is subjected to binarization processing, and the horizontal Feret's diameters of 100 particles of one type of the external additive are calculated, taking the mean value thereof as the number-average particle diameter. Here, the “horizontal Feret's diameter” refers to the length of a side parallel to the x-axis of a circumscribed rectangle when an image of the external additive is binarized. In a case in which the number average primary particle diameter of the external additive is a small diameter and is present on the toner surface as an aggregate, the particle diameter of the primary particles forming the aggregate is measured.

### (1.4) Other Components

### (Binder Resin)

The electrostatic charge image development toner according to an aspect of the present invention may contain a binder resin.

The term “binder resin” refers to a resin that is used as a medium or matrix (base) for dispersing and retaining internal additives (a release agent, a charge control agent, a colorant, and the like) and external additives (silica, titanium oxide, and the like) contained in toner particles, and has a function of adhering to a recording medium (for example, sheet) during a fixing process of a toner image.

In the toner of an aspect of the present invention, conventionally known binder resins, for example, a crystalline resin and an amorphous resin can be applied as a binder resin. For example, one or more of polymer materials such as polyester, polyethylene, and polypropylene may be used. Among them, the binder resin is preferably polyester. This is because the surface of the brilliant image (toner image described later) is easily smoothened, and thus the brilliance property is less likely to decrease and is less likely to vary. The polyester is, for example, a reaction product (condensation polymer) of one or more alcohols and one or more carboxylic acids.

The type of the alcohol is not particularly limited, but among them, a divalent or higher alcohol and a derivative thereof are preferable. Specific examples of the dihydric or higher hydric alcohol include ethylene glycol, diethylene glycol, triethylene glycol, polyethylene glycol, propylene glycol, butanediol, pentanediol, hexanediol, cyclohexanedimethanol, xylene glycol, dipropylene glycol, polypropylene glycol, bisphenol A, hydrogenated bisphenol A, bisphenol A ethylene oxide, bisphenol A propylene oxide, sorbitol, and glycerin.

The type of the carboxylic acid is not particularly limited, but among them, a divalent or higher carboxylic acid and a derivative thereof are preferable. Specific examples of the divalent or higher carboxylic acid include maleic acid, fumaric acid, phthalic acid, isophthalic acid, terephthalic acid, succinic acid, adipic acid, trimellitic acid, pyromellitic acid, cyclopentanedicarboxylic acid, succinic anhydride, trimellitic anhydride, maleic anhydride, and dodecenyl succinic anhydride.

The binder resin preferably contains at least a styrene-acrylic resin. By containing the styrene-acrylic resin, it is possible to suppress excessive bleeding of the release agent at the time of fixing the toner, to improve the fixing separability, and to suppress contamination in the machine due to the release agent. Furthermore, other known resins may also be contained within a range that does not impair the effects of the present invention.

### (Release Agent)

The electrostatic charge image development toner according to an aspect of the present invention may contain a release agent, and the release agent can enhance the releasability of the toner from a fixing member or the like.

Examples of the release agent include hydrocarbon waxes such as polyethylene wax, paraffin wax, microcrystalline wax and Fischer-Tropsch wax, dialkyl ketone waxes such as distearyl ketone, carnauba wax, montan wax, behenyl behenate, behenic acid behenate, trimethylolpropane tribehenate, pentaerythritol tetramyristate, pentaerythritol tetrastearate, pentaerythritol tetrabehenate, pentaerythritol diacetate dibehenate, glycerin tribehenate, 1,-18-octadecanediol distearate, tristearyl trimellitate, ester waxes such as distearyl maleate, and amide waxes such as ethylenediamine dibehenylamide and tristearylamide trimellitate.

A content of the release agent is preferably in a range of 2 to 30 mass %, more preferably in a range of 5 to 20 mass % with respect to a total mass of the toner base particle. When the content of the release agent is 2% by mass or more, the releasability of the toner from a fixing member is sufficiently enhanced. When the content of the release agent is 30% by mass or less, a sufficient amount of the binder resin can be contained in the toner base particles, and thus the fixability of an image is sufficiently enhanced.

### (Charge Control Agent)

The electrostatic charge image development toner according to an aspect of the present invention may contain a charge control agent, and the charge control agent can adjust the charging property of the toner base particles. Examples of the charge control agent include nigrosine dyes, metal salts of naphthenic acid or higher fatty acids, alkoxylated amines, quaternary ammonium salt compounds, azo metal complexes, salicylic acid metal salts or metal complexes thereof, and the like. The content of the charge control agent is preferably in the range of 0.1 to 10% by mass and more preferably in the range of 0.5 to 5% by mass with respect to the total mass of the binder resin.

### (Colorant)

As the colorant other than the brilliant pigment, carbon black, a magnetic material, a dye, a pigment, and the like can be arbitrarily used, and these colorants can be used alone or in combination of two or more thereof as necessary. The addition amount of the colorant is preferably within a range of 1 to 30 mass %, more preferably within a range of 2 to 20 mass %, with respect to the entire toner, and a mixture thereof can also be used, and within such a range, color reproducibility of an image can be ensured. The size of the colorant is preferably in the range of 10 to 1000 nm, preferably in the range of 50 to 500 nm, and more preferably in the range of 80 to 300 nm in terms of volume-average particle diameter.

### (1.5) Structure and Shape of Toner Particle

### (Core-Shell Structure)

The toner base particle may be used as it is in a toner, but may be a toner particle having a multilayer structure such as a core-shell structure including the toner base particle as a core particle and a shell layer covering a surface of the core particle.

The shell layer may not cover the entire surface of the core particle, and the core particle may be partially exposed. The cross section of the core-shell structure can be confirmed by a known observation section such as a transmission electron microscope (TEM) or a scanning probe microscope (SPM).

In the case of a core-shell structure, characteristics such as a glass transition point, a melting point, and hardness can be made different between the core particle and the shell layer, and it is possible to design the toner particle according to the purpose.

For example, the shell layer can be formed by aggregating and fusing a resin having a relatively high glass transition point (Tg) on the surface of a core particle containing a binder resin, a colorant, a release agent, and the like and having a relatively low glass transition point (Tg). It is preferable that the shell layer contains an amorphous resin.

### (Particle Diameter)

As for the particle diameter of the toner particle, a volume-based median diameter (d₅₀) is preferably within a range of 3 to 10 μm, more preferably within a range of 5 to 8 μm. Within the above range, high reproducibility is achieved even in the case of an extremely fine dot image at a 1200 dpi level.

The particle diameter of the toner particle can be controlled by the concentration of an aggregating agent or the amount of an organic solvent to be added, which is used in production, the fusion time, the composition of the binder resin, and the like.

For measurement of the volume-based median diameter (d₅₀) of the toner particles, a measurement apparatus can be used in which a computer system equipped with Software V3.51 for data processing is connected to Multisizer 3 (manufactured by Beckman Coulter).

Specifically, a measurement sample (toner) is added to and mixed with a surfactant solution (for the purpose of dispersing toner particles, for example, a surfactant solution prepared by diluting a neutral detergent containing a surfactant component 10-fold with pure water), followed by ultrasonic dispersion to prepare a toner particle dispersion liquid. The toner particle dispersion liquid is injected into a beaker containing ISOTONII (manufactured by Beckman Coulter, Inc) in a sample stand with a pipette until the display concentration of the measurement device becomes 8%. Here, by setting this concentration, reproducible measurement values can be obtained. Then, in the measurement apparatus, the measurement particle count number is set to 25000, the aperture diameter is set to 100 μm, the frequency value is calculated by dividing the measurement range of 2 to 60 μm into 256 parts, and the particle diameter of 50% from the larger volume integrated fraction is obtained as the volume-based median diameter (d₅₀).

### (Average Circularity)

The toner particles preferably have an average circularity in the range of 0.930 to 1.000, and more preferably in the range of 0.950 to 0.995, from the viewpoint of enhancing the stability of charging property and low-temperature fixability. When the average circularity is within the above-described range, individual toner particles are not easily broken. As a result, contamination of the frictional charge-providing member can be suppressed to stabilize the charging property of the toner, and the quality of an image to be formed can be enhanced.

The average circularity of the toner particles can be measured using FPIA 2100 (manufactured by Sysmex Corporation). Specifically, a measurement sample (toner) is mixed with an aqueous solution containing a surfactant, and ultrasonic dispersion treatment is performed for 1 minute to disperse the sample. Thereafter, imaging is performed by FPIA-2100 (manufactured by Sysmex Corporation) under measurement conditions of an HPF (high magnification imaging) mode at an appropriate density of 3000 to 10,000 HPF detections. When the number of HPF detections is within the above range, reproducible measured values can be obtained.

From the photographed particle image, the circularity of each toner particle is calculated according to the following formula (I), and the average circularity is obtained by adding the circularity of each toner particle and dividing by the total number of toner particles.

$$Circularity = ( perimeter of a circle having the same projected area as the particle image ) / ( perimeter of the particle projected image ) \qquad Expression ( I )$$

### (1.6) Method for Producing Toner Base Particles

The toner base particle can be produced in the same manner as a known toner by a method such as an emulsion polymerization aggregation method or an emulsion aggregation method.

According to the emulsion polymerization aggregation method, a dispersion liquid of particles of a binder resin obtained by an emulsion polymerization method and a dispersion liquid of particles of a pigment are mixed together with optionally added particles such as a release agent and a charge control agent. Then, these are aggregated, associated, or fused until particles having a desired particle diameter are obtained, and thereafter, an external additive is added, whereby the above can be obtained.

According to the emulsion aggregation method, a dispersion liquid of particles of a binder resin, which is obtained by adding dropwise a solution containing a binder resin dissolved therein to a poor solvent, is mixed with a dispersion liquid of particles of a pigment, together with optionally added particles such as a release agent and a charge control agent. Then, these are aggregated, associated, or fused until particles having a desired particle diameter are obtained, and thereafter, an external additive is added, whereby the above can be obtained.

In the present embodiment, since two or more kinds of pigments are internally added to the toner particles, the addition amount of the pigments is likely to be increased. Therefore, when a dispersion liquid of pigment particles is prepared, a surfactant is preferably added to the dispersion liquid in order to enhance the dispersion stability of the pigment.

### (1.7) Developer

The electrostatic charge image development toner according to an aspect of the present invention can be used as a mono-component developer, but may be mixed with a carrier and used as a two-component developer. The carrier is mixed with the above-described toner particles to constitute a two component magnetic toner. The carrier may be any known magnetic particle that can be contained in a toner. Examples of the magnetic particles include particles containing magnetic materials such as iron, steel, nickel, cobalt, ferrite, and magnetite, and alloys of these materials with aluminum, lead, and the like.

The carrier may be a coated carrier in which the surface of a particle made of the magnetic material is coated with a resin or the like, or may be a resin-dispersed carrier in which the magnetic material is dispersed in a binder resin.

Examples of the resin for coating the magnetic particles include an olefin resin, a styrene resin, a styrene-acrylic resin, a silicone resin, a polyester resin, and a fluororesin.

Examples of the binder resin include acrylic resins, styrene-acrylic resins, polyester resins, fluororesins, and phenol resins.

The average particle diameter of the carrier is preferably in the range of 20 to 100 μm, and more preferably in the range of 25 to 80 μm in terms of volume-based average particle diameter. The average particle diameter of the carrier can be measured with HELOS (manufactured by SYMPATEC Co., Ltd) which is a laser diffraction type particle size distribution measuring apparatus equipped with a wet dispersing machine.

The content of the carrier is preferably in the range of 2 to 10 mass % with respect to the total mass of the toner particles and the carrier.

### 2. Image Forming Method

An image forming method of an aspect of the present invention is an image forming method for forming an image on continuous sheet by using an electrostatic charge image development toner, wherein the electrostatic charge image development toner contains toner base particles containing a binder resin and a brilliant pigment having a coating layer containing an inorganic element. Hereinafter, the image forming method of an aspect of the present invention will be described, but the brilliant pigment, the binder resin, and the like contained in the toner base particles contained in the electrostatic charge image development toner are as described above.

### (2.1) the Effect of the Brilliant Pigment on the Surface of the Fixing Member

In a case where an image is formed using a brilliant pigment which does not have a coating layer, the surface of the fixing member may be damaged by the brilliant pigment depending on the shape of the brilliant pigment, and a scratch phenomenon may occur. In this case, debris generated by the scratch phenomenon covers the light source, and therefore, streak unevenness is likely to occur during image formation. For example, in a case where the exposure section (exposure device) is a laser light source including a single light source, streak unevenness can be suppressed by increasing the output of the laser light source itself to which the aforementioned debris adheres.

In contrast, in a case where an exposure section (exposure device) is an LED light source including a plurality of light sources, it is difficult to identify a light source to which a dust particle adheres, and the darkening of the light source to which the dust particle adheres tends to cause streak unevenness in image formation.

From the above-described viewpoint, in the image forming system of an aspect of the present invention, scratches on the surface of the fixing member are suppressed by using the electrostatic charge image development toner containing the brilliant pigment coated with the above-described coating layer.

Accordingly, the scratch phenomenon hardly occurs, and even in a case where the exposure section (exposure device) is an LED light source, the light source does not become dark, which is suitable.

### (2.2) Influence of Passing State of Cut Sheet and Continuous Sheet on the Surface of the Fixing Member in Continuous Printing

In the image forming system of an aspect of the present invention, when an image is formed, continuous sheet is used as a recording medium instead of cut sheet.

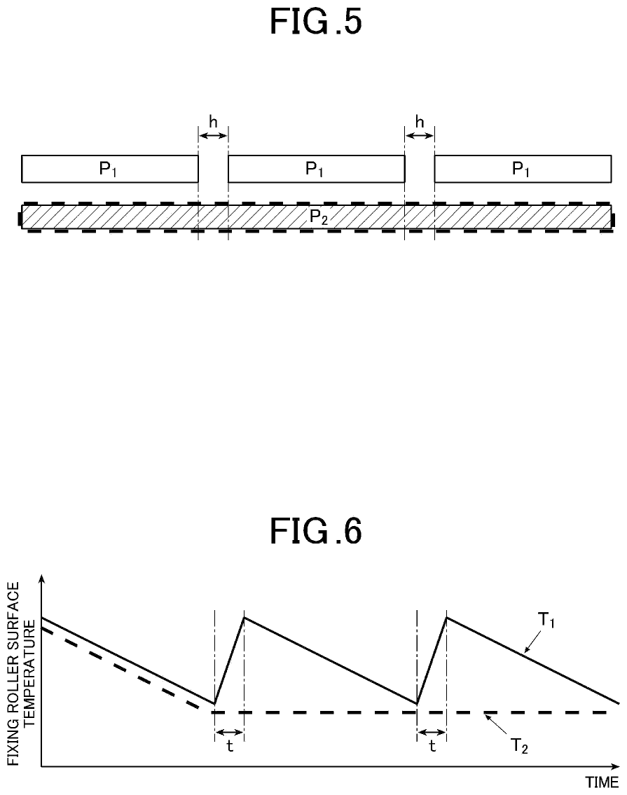

FIG. 5 is an example of a conceptual diagram of a sheet passing state of a cut sheet and a continuous sheet during continuous printing. The sheet P₁ is a sheet obtained by cutting sheet into a certain size such as A size or B size. The continuous sheet P₂ is a long sheet on which continuous printing can be performed, and for example, has round holes (sprocket holes) at both left and right ends so that the sheet can be fed by being set in a sheet feed device (not illustrated), and has perforations with a certain length so as to be easily cut. As shown in FIG. 5, the sheets P₁ have a width h between the sheets P₁ unlike the continuous sheets P₂ and when printing is performed while passing sheets, a time t is required for the sheets P₁ which are recording medium, to pass through the width h between the sheets P₁.

FIG. 6 is a conceptual diagram illustrating a relationship between a change in the surface temperature of the fixing member and time in a sheet passing state of a cut sheet and a continuous sheet during continuous printing. Here, the fixing member is a fixing belt and a pressure roller which constitute a fixing nip. As illustrated in FIG. 6, during continuous printing, when the sheet P₁ is used as the recording medium, there is a recovery timing of the surface temperature T₁ of the fixing member, but when the continuous sheet P₂ is used as the recording medium, there is no recovery timing of the surface temperature T₂ of the fixing member, and the surface temperature of the fixing member remains low.

The above-described “timing of return of the surface temperature of the fixing member” is a time required for a width h of an interval between sheets in FIG. 5 to pass through the fixing member (e.g., fixing belt or the like), and is represented by t in FIG. 6.

When the section for forming an image on the continuous sheet P₂ is provided with the surface temperature adjusting section for the fixing member, the lowering of the surface temperature of the fixing member on the continuous sheet P₂ can be prevented and the surface temperature of the fixing member can be stabilized to prevent image defects such as streak unevenness at the time of image formation.

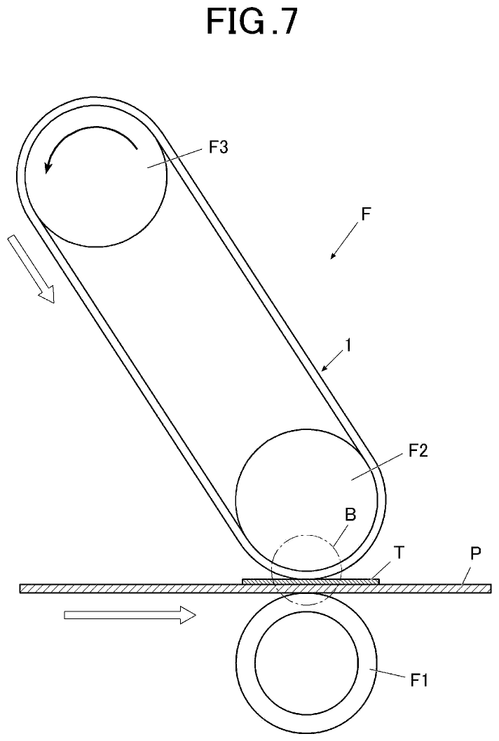

FIG. 7 is a simplified view of an example of a fixing member according to an aspect of the present invention. A fixing device (fixing member) F includes a fixing roller F₂, a heating roller F3, and a fixing belt 1, and a toner T is transferred, at a nip part B, between the fixing roller F2 and the fixing belt 1, onto a recording medium P conveyed by the fixing device F and a conveyance roller F1, and an image is formed. The fixing device (fixing member) can be a surface temperature adjusting section, and for example, may be a heating conveyance roller by incorporating a heater or the like in the conveyance roller F1

### (2.3) Section for Forming Image on Continuous Sheet

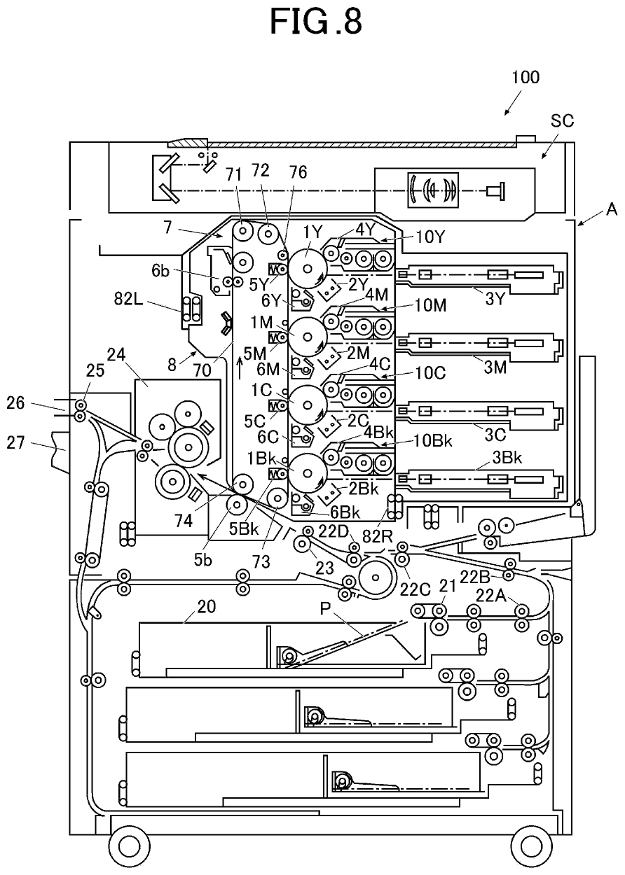

The section for forming an image on continuous sheet according to an aspect of the present invention may be a four cycle image forming apparatus including four types of color developing devices for yellow, magenta, cyan, and black and one electrophotographic photoreceptor. Alternatively, the image forming apparatus may be a tandem-type image forming apparatus including four types of color developing devices for yellow, magenta, cyan, and black and four electrophotographic photoreceptors provided for the respective colors. Specifically, for example, the section for forming an image on continuous sheet according to an aspect of the present invention may be an image forming apparatus as shown in FIG. 8.

### (2.3.1) Schematic Configuration Diagram of an Example of an Image Forming Apparatus

### (Image Forming Apparatus 100)

FIG. 8 is a diagram illustrating an example of a configuration of an image forming apparatus used at the time of image formation. An image forming apparatus 100 illustrated in FIG. 8 includes an image forming apparatus body A including image forming units 10Y, 10M, 10C, and 10Bk, an intermediate transfer unit 7, and a fixing section 24.

The image forming units 10Y, 10M, 10C, and 10Bk form yellow, magenta, cyan, or black toner images, respectively.

The intermediate transfer unit 7 transfers the toner images of the respective colors formed in the image forming units 10Y, 10M, 10C, and 10Bk onto the recording medium P.

Furthermore, in an upper part of the image forming apparatus main body A, a document image reading device SC for reading image information as digital data (document image data) by optically scanning a document is arranged.

### [Image Forming Unit]

The image forming units 10M, 10C, and 10Bk form toner images with a magenta toner, a cyan toner, and a black toner, respectively, instead of the yellow toner, and basically have the same configuration as the image forming unit 10Y. Therefore, the image forming unit 10Y will be described in detail below.

The image forming units 10M, 10C, and 10Bk form toner images with a magenta toner, a cyan toner, and a black toner, respectively, instead of the yellow toner, and basically have the same configuration as the image forming unit 10Y.

The image forming unit 10Y includes a charging section 2Y, an exposure section 3Y, a development section 4Y, and a cleaning section 6Y, and forms a toner image of yellow (Y) on the photoreceptor 1Y.

The charging section 2Y applies a uniform potential to the periphery of the drum-shaped photoreceptor 1Y, which is an image forming member, on the surfaces of the photoreceptor 1Y.

The exposure section 3Y performs exposure on the uniformly charged photoreceptor 1Y based on the image data signal for exposure (yellow), and forms an electrostatic latent image corresponding to the yellow image.

The development section 4Y conveys toner onto the photoreceptor 1Y to visualize the electrostatic latent images.

The cleaning section 6Y collects residual toner remaining on the photoreceptor 1Y after the primary transfer.

First of all, a corona discharge type charger is used as the charging section 2Y.

The exposure section 3Y is composed of a light emitting device which uses a light emitting diode as an exposure light source and which is composed of, for example, an LED part in which light emitting elements composed of light emitting diodes are arranged in an array in the axial direction of the photoreceptor 1Y and an image forming element, a laser emitting device of a laser optical system which uses a semiconductor laser as an exposure light source and the like.

In the image forming apparatus 100 shown in FIG. 8, a laser irradiation device is provided.

The exposure section 3Y is preferably composed of a device using a semiconductor laser diode or a light emitting diode having an oscillation wave length of 350 to 850 nm as an exposure source. An electrophotographic image with a resolution of 600 dpi to 2400 dpi or higher can be obtained by performing digital exposure on the photoreceptor 1Y using such an exposure light source with an exposure dot size in the main scanning direction of writing being narrowed to 10 to 100 μm.

An exposure method in the exposure section 3Y may be a scanning optical system using a semiconductor laser, or may be a solid-state method using an LED.

Regarding the light intensity distribution, a Gaussian distribution, a Lorentz distribution, distribution, and the like, but a region of 1/e² or more of each peak intensity may be set as the exposure dot diameter.

In the image forming apparatus 100, the photoreceptor 1Y, the charging section 2Y, the development section 4Y, and the cleaning section 6Y of the image forming unit 10Y are provided as an integrated process cartridge. The process cartridge may be detachably attached to the main body A of the image forming apparatus by using a guide section such as a rail. The process cartridge may be configured such that least one of the charging section 2Y, the exposure section 3Y, the development section 4Y, the primary transfer roller 5Y, and the cleaning section 6Y is supported integrally with the photoreceptor 1Y.

[intermediate transfer unit] The intermediary transfer unit 7 includes an intermediary transfer member 70 in the form of an endless belt, primary transfer rollers 5Y, 5M, 5C, and 5Bk, a secondary transfer roller 5b, and a cleaning section 6b.

The intermediate transfer body 70 in the form of an endless belt is stretched by a plurality of support rollers 71 to 74 and is supported so as to be capable of circulating.

The primary transfer rollers 5Y, 5M, 5C, and 5Bk transfer the toner images formed by the image forming units 10Y, 10M, 10C, and 10Bk, respectively, to the intermediate transfer member 70.

The secondary transfer roller 5b transfers the toner image, which has been transferred onto the intermediate transfer member 70 by the primary transfer rollers 5Y, 5M, 5C, and 5Bk, onto the recording medium P.

The cleaning section 6b collects residual toner remaining on the intermediate transfer member 70.

The primary transfer roller 5Bk in the intermediate transfer unit 7 is always in contact with the photoreceptor 1Bk during the image formation processing. The other primary transfer rollers 5Y, 5M, and 5C are made to abut on the corresponding photoreceptors 1Y, 1M, and 1C, respectively, only when a color image is formed.

Furthermore, the secondary transfer roller 5b is made to abut on the intermediate transfer member 70 only when the recording medium P passes here and the secondary transfer is performed.

[housing] Components other than the secondary transfer roller 5b of the intermediate transfer unit 7 and the process cartridges of the image forming units 10Y, 10M, 10C, and 10Bk are housed in a housing 8. The housing 8 is configured to be drawable from the image forming apparatus main body A via support rails 82 L and 82R.

### <Charging Section>

In the image forming apparatus 100 as described above, the surfaces of the photoreceptors 1Y, 1M, 1C, and 1Bk are charged by charging section 2Y, 2M, 2C, and 2Bk.

### <Exposure Section>

The exposure sections 3Y, 3M, 3C, and 3Bk are operated in accordance with the exposure image-data signals of the respective colors obtained by performing various kinds of image processing on the document image-data obtained by the document image reading device SC.

Specifically, laser light modulated correspondingly to the image data signal for exposure is output from an exposure light source, and the photoreceptors 1Y, 1M, 1C, and 1Bk are scanned and exposed by the laser light. Thus, electrostatic latent images corresponding to the respective colors of yellow, magenta, cyan, and black corresponding to the document read by the document image reading device SC are formed on the 1Y, 1M, 1C, and 1Bk of the respective photoreceptors.

### <Development Section>

Then, the electrostatic latent images formed on the 1Y, 1M, 1C, and 1Bk of the photoreceptor are developed with toners of the respective colors by development section 4Y, 4M, 4C, and 4Bk, whereby toner images of the respective colors are formed. Then, the toner images of the respective colors are sequentially transferred onto the intermediate transfer member 70 by the primary transfer rollers 5Y, 5M, 5C, and 5Bk, and are superimposed and synthesized, whereby a color toner image is formed.

Furthermore, in synchronization with the formation of the color toner image, a recording medium P stored in a sheet feed cassette 20 is fed by a sheet feed section 21 and conveyed to a secondary transfer roller 5b via a plurality of intermediate rollers 22A, 22B, 22C, 22D and a registration roller 23.

### <Transfer Section: Secondary Transfer Roller>

Then, the color toner image transferred onto the intermediate transfer member 70 by the secondary transfer roller 5b is collectively transferred onto the recording medium P.

### <Fixing Section>

The color toner image transferred onto the recording medium P is fixed by a fixing section 24, for example, by heating and pressurizing, to form a visible image (toner layer).

### <Others>

Thereafter, the recording medium P on which the visible image is formed is ejected by a sheet ejection roller 25 through an ejection port 26 to the outside of the apparatus and placed on a sheet ejection tray 27.

After the toner images of the respective colors are transferred to the intermediate transfer body 70, toners remaining on the photoreceptors 1Y, 1M, 1C, and 1Bk are removed by cleaning sections 6Y, 6M, 6C, and 6Bk, respectively, and then the photoreceptors are used to form the next toner images of the respective colors.

On the other hand, after the color toner image is transferred onto the recording medium P by the secondary transfer roller 5b and the recording medium P is subjected to curvature separation, the toner remaining on the intermediate transfer member 70 is removed by a cleaning section 6b, and then the intermediate transfer member 70 is ready for the intermediate transfer of the next toner image.

### EXAMPLE

Hereinafter, the present invention will be specifically described with reference to Examples, but the present invention is not limited thereto. In Examples, “part (s)” or “%” is used to indicate “part (s) by mass” or “% by mass” unless otherwise specified.

### A. Production of Image Forming Apparatus

### (A. 1) Production of Fixing Belt

### (Production of Base Material Belt)

A varnish containing polyamic acid (a polymer obtained by dehydration condensation of 3, 3′,4,4′-biphenyl tetracarboxylic acid dianhydride and p-phenylenediamine) and 8% by mass of carbon black with respect to the polymer was applied to the outside of the cylindrical mold by rotation. The sample was imidized by drying at 300° C. to 450° C. Thus, a cylindrical polyimide tubular product (base material belt) having an inner diameter of 99 mm, a length of 360 mm, and a thickness of 70 μm was produced.

### (Formation of Elastic Layer)

Next, a cylindrical mandrel made of outer diameter 99 mm stainless steel was brought into close contact with the inner side of the base material belt, and a cylindrical mold holding a 30 μm-thick PFA tube on the inner peripheral surface thereof was placed on the outer side of the base material belt. In this way, the core metal and the cylindrical mold were held coaxially, and a cavity was formed between the two. Next, a silicone rubber material (type A, rubber hardness of 30°, tensile strength of 1.5 MPa, heat conductivity of 0.7 W/(m K), and elongation of 250%) was injected into the cavity and heated and cured to form a 200 gm-thick elastic layer of silicone rubber.

### (A. 2) Manufacture and Attachment of a Fixing Device

According to a known method, a fixing device was produced with the configuration illustrated in FIG. 7, which was composed of a heating conveyance roller (conveyance roller, F1), a fixing roller (first roller, F2) placed on the upper surface side, and a heating roller (second roller, F3) placed above the fixing roller F2, and in which the fixing belt having a thermoplastic resin layer as an outermost layer produced as described above was stretched between the first roller F2 and the second roller F3.

Thereafter, the fixing device was mounted in a full color copier “bizhub PRESS C1070” (manufactured by Konica Minolta, Inc) to produce an image forming apparatus.

### B. Production of Brilliant Pigment

In the following Examples, for the sake of convenience, the “brilliant pigment having a coating layer” includes both a brilliant pigment having an oxide film and a brilliant pigment having a resin coating. In addition, the term “brilliant material” refers to metal particles such as a pigment before the formation of the coating layer.

### (B. 1) Production of a Brilliant Pigment Having a Coating Layer

### (Material Used for Producing Brilliant Pigment: Brilliant Material)

For the production of the brilliant pigment, brilliant materials [1] to [5] described in Table I were used. The pigment type, average particle diameter, thickness, and aspect ratio are as described in Table I. As described above, the “aspect ratio” refers to the ratio (W/H) of the short axis particle diameter W to the thickness H, where the long axis particle diameter L is the maximum length of the pigment particle, the short axis particle diameter W is the maximum length in a direction intersecting the long axis particle diameter L, and the thickness H is the minimum length in a direction orthogonal to the long axis particle diameter L.

The average thickness of the pigment particles is an average value of thicknesses measured for arbitrary 100 pigment particles, and the average long axis particle diameter of the pigment particles is an average value of long axis particle diameters measured for arbitrary 100 pigment particles.

Furthermore, the thickness and particle diameter (including long axis particle diameter and short axis particle diameter) of each of the pigment particles were measured as follows: the pigment particle was sprinkled on a double-sided tape to be fixed, and the surface thereof was observed using a microscope VHX-6000 at a magnification with which the shape of the pigment particle can be confirmed. Then, the observed image was subjected to binarization processing by LUSEX-AP manufactured by Nireco Corporation, and the long-axis particle diameter L, the short-axis particle diameter W, and the height H were measured for arbitrary 100 pigment particles, and the averages thereof were adopted. The measurement of the aspect ratio of the pigment particles is performed on the metal or metal oxide particles before the surface treatment and does not include those after the surface treatment.

TABLE I
BRILLIANT MATERIAL

| | | AVERAGE | | | | | |
|---|---|---|---|---|---|---|---|
| | | PARTICLE | | | | | |
| | PIGMENT | DIAMETER | THICKNESS | AR | | PRODUCT | |
| No. | TYPE | [μm] | [μm] | *1 | SHAPE | NAME | MANUFACTURER |
| [1] | Al | 1 | 0.5 | 2 | FLAKE | 7670NS | MANUFACTURED BY |
| | | | | | SHAPE | | TOYO ALUMINIUM K. K. |
| [2] | Al | 6 | 0.5 | 12 | FLAKE | 7670NS | MANUFACTURED BY |
| | | | | | SHAPE | | TOYO ALUMINIUM K. K. |
| [3] | Al | 12 | 0.5 | 24 | FLAKE | 7670NS | MANUFACTURED BY |
| | | | | | SHAPE | | TOYO ALUMINIUM K. K. |
| [4] | Al | 24 | 0.5 | 48 | FLAKE | 7670NS | MANUFACTURED BY |
| | | | | | SHAPE | | TOYO ALUMINIUM K. K. |
| [5] | Al | 12 | 0.3 | 24 | FLAKE | 7670NS | MANUFACTURED BY |
| | | | | | SHAPE | | TOYO ALUMINIUM K. K. |

*1: ASPECT RATIO
“Al” REFERS TO ALUMINUM

### (B.1.1) Preparation of Brilliant Pigments <<1>>

(Formation of Coating Layer that Covers Brilliant Material)

The brilliant material [1] 64 g was placed in a glass beaker and dispersed in mineral spirit 300 g. Next, trimethylolpropane triacrylate (TMP) 4.2 g [0.0141 mol], benzyl methacrylate (BM) 1.2 g [0.00681 mol], acrylic acid (AA) 0.05 g [0.000694 mol], and azobisisobutyronitrile 0.2 g were added.

Thereafter, the mixture was heated under stirring, stirring was continued at 90° C. for 2 hours, and filtration was performed after completion of the reaction to obtain a filtration cake (filter cake). The filter cake (filter residue) was washed with mineral spirits, and then, the concentration was adjusted with mineral spirit to obtain a paste containing 48% by mass of an aluminum component.

A part of the paste was taken and dried, dissolved in aqua regia, and the resin component was filtered, washed with water, and dried to obtain a brilliant pigment <<1>>. The amount of the coating resin of the brilliant pigment<<1>> obtained by measuring the weight thereafter was 11.5 parts by mass (resin yield 95%) per 100 parts by mass of aluminum.

After toner particles which will be described later, were formed using the brilliant pigment <<1>> thus obtained, the average long axis diameter and the average thickness of the toner particles were measured on a fixed image, and the average long axis diameter was 1.1 μm and the average thickness was 0.6 μm.

### (B. 1.2) Preparation of Brilliant Pigments <<2>> to >> 7>> and <<9>>

Brilliant pigments <<2>> to <<7>> and <<9>> were produced in the same manner as the brilliant pigment <<1>> except that the stirring conditions were appropriately changed and the kind of the brilliant material was changed as shown in Table II. Table II shows respective values related to the brilliant materials and the coating layers of the produced brilliant pigments.

### (B. 1.3) Production of Brilliant Pigment <<12<<

### (Preparation of Brilliant Material)

As examples of the brilliant material, the brilliant materials [5] (aluminum pigment, average long axis diameter of 18 μm and an average thickness of 0.3 μm) was used.

### (Formation of Coating Layer)

### Synthesis of Polyester [a]

The following ingredient [1] was placed in a 10 L four flask equipped with a nitrogen gas introducing tube, a dewatering tube, a stirrer and a thermo couple, and reacted at 230° C. for 8 hours, and then reacted at 8.3 kPa for 1 hour. Then, the temperature was lowered to 210° C., the following component [2] was further added, and a reaction was performed until a desired softening point was reached, thereby synthesizing a polyester [a].

### <Component [1]>

bisphenol a propylene oxide adduct (bpa-po) 4900 parts by mass
bisphenol A ethylene oxide adduct (BPA-EO) 1950 parts by mass
terephthalic acid 1328 parts by mass
2-tin (ii) ethylhexanoate 40 parts by mass
gallic acid 1 part by mass

### <Component [2]>

trimellitic anhydride 5 parts by mass
fumaric acid 5 parts by mass
tert-butylcatechol 5 parts by mass

### <Preparation of Resin Particles [α]>

The polyester [a] was premixed for 1 minute using a Henschel mixer and then melt-kneaded using a twin-screw extruder (PCM-87, manufactured by Ikegai Corporation) to obtain a kneaded product. As conditions for the melt-kneading, a feed rate of the raw materials was set to 3.0 kg/min, and the rotation of a screw in a kneading section was set to 200 rpm, and furthermore, a barrel setting temperature was set to 170° C. so that a temperature of the kneaded product measured at a kneaded product ejection section would be 160° C. The resulting kneaded mixture was cooled to 20° C. or less while being rolled with a cooling roll, and the cooled melt-kneaded mixture was roughly pulverized to about 3 mm with a ROTOPLEX (manufactured by Toagosei Co., Ltd) to prepare resin particles [α].

### <Preparation of Resin Particle Dispersion Liquid (A)>

The obtained coarsely pulverized product (resin particle [α]) is mixed with toluene in the following ratio, and thus a resin particle dispersion liquid (A) is prepared.
toluene 80 parts by mass
resin particles [α] 20 parts by mass

### <Spraying of Resin Particle Dispersion Liquid (A)>

The resin particle dispersion liquidn (A) was sprayed from a spray nozzle onto the following components using a fluidized bed type coating apparatus (Wurster type fluidized bed coating apparatus, trade name: GM-140, manufactured by DALTON corporation) to prepare a brilliant pigment <<12>> in which the resin particle dispersion liquid (A) is adhered onto the brilliant material [5] (aluminum pigment, average long axis diameter: 18 gm, average thickness: 0.3 gm). In the fluidized bed coater, the amount of the resin particle dispersion liquid (A) sprayed from the spray nozzle was 5 g/min. Further, the temperature of the fluidizing air was 60° C., and the amount of the fluidizing air jetted from the central region and the peripheral region of the gas dispersion plate was 0.5 m³/min. The mass of the brilliant material [5] (aluminum pigment) and the mass of the resin particle dispersion liquid (A) are as follows.

brilliant material [5] (aluminum pigment) 50 parts by mass resin particle dispersion liquid (A) 100 parts by mass

### (B. 1.4) Production of Brilliant Pigment <<13>>

brilliant pigment <<13>> was prepared in the same manner as the brilliant pigment <<12>> except that in the spraying of the resin particle dispersion liquid (A), the amount of the resin particle dispersion liquid (A) sprayed from the spray nozzle is adjusted and the thickness of the coating layer is changed as illustrated in Table II.

### (B. 1.5) Preparation of Brilliant Pigment <<8>>

A brilliant pigment <<8>> was produced in the same manner as the brilliant pigment <<1>> except that the stirring conditions were appropriately changed, the kind of the brilliant material was changed as shown in Table II, and the oxide film was formed before the formation of the resin coating in the formation of the coating layer covering the brilliant material. The values of the produced brilliant pigment are shown in Table II. The formation of the oxide film was performed as follows.

At room temperature (25° C.), an oxide film was formed by carrying out an anodizing treatment in a 15% by mass sulfuric acid at a constant DC voltage such that the thickness of the oxide film was 0.1 μm and removing the remaining photoresist layer in a photoresist remover solution.

### (B. 2) Production of Brilliant Pigment Covered by Oxide Film Only

### (B. 2.1) Preparation of Brilliant Pigment <<10>>

A brilliant pigment <<10>> was produced in the same manner as the brilliant pigment <<1>> except that the stirring conditions were appropriately changed, the kind of the brilliant material was changed as in Table II, and an oxide film was formed as the coating layer covering the brilliant material. The values of the produced brilliant pigment are shown in Table II. The formation of the oxide film was performed in the same manner as in the brilliant pigment <<8>>.

### (B. 2.2) Preparation of Brilliant Pigment <<11>>

A brilliant pigment <<11>> was produced in the same manner as the brilliant pigment <<1>> except that the stirring conditions were appropriately changed, the kind of the brilliant material was changed as in Table II, and an oxide film was formed as the coating layer covering the brilliant material. The values of the produced brilliant pigment are shown in Table II. The formation of the oxide film was performed in the same manner as in the brilliant pigment <<8>> except that the anodizing treatment was performed at a DC constant voltage so that the thickness of the oxide film became 0.4 μm.

TABLE II

| | | | | | | COATING LAYER | | | |
|---|---|---|---|---|---|---|---|---|---|
| | BRILLIANT MATERIAL | | | | | RESIN COATING | | | |
| | | | AVERAGE | | | CONTAlNING | | | OXIDE |
| | | | PARTICLE | | | COMPOUND | | | FILM |
| | | PIGMENT | DIAMETER | THICKNESS | AR | | AMOUNT | THICKNESS | THICKNESS |
| *1 | No. | TYPE | [μm] | [μm] | *2 | TYPE | [g] | [μm] | [μm] |
| [symbol] 1 [symbol] | (1) | Al | 1 | 0.5 | 2 | TEOS | 5 | 0.1 | — |
| [symbol] 2 [symbol] | [2] | Al | 6 | 0.5 | 12 | TEOS | 10 | 0.1 | — |
| [symbol] 3 [symbol] | [2] | Al | 6 | 0.5 | 12 | TEOS | 30 | 0.3 | — |
| [symbol] 4 [symbol] | [3] | Al | 12 | 0.5 | 24 | TEOS | 40 | 0.1 | — |
| [symbol] 5 [symbol] | [3] | Al | 12 | 0.5 | 24 | TEOS | 3.2 | 0.008 | — |
| [symbol] 6 [symbol] | (3) | Al | 12 | 0.5 | 24 | TEOS | 240 | 0.6 | — |
| [symbol] 7 [symbol] | [3] | Al | 12 | 0.5 | 24 | TEOS | 120 | 0.3 | — |
| [symbol] 8 [symbol] | [3] | Al | 12 | 0.5 | 24 | TEOS | 80 | 0.2 | 0.1 |
| [symbol] 9 [symbol] | [4] | Al | 24 | 0.5 | 48 | TEOS | 80 | 0.1 | — |
| [symbol] 10 [symbol] | [2] | Al | 6 | 0.5 | 12 | — | — | — | 0.1 |
| [symbol] 11 [symbol] | [2] | Al | 6 | 0.5 | 12 | — | — | — | 0.4 |
| [symbol] 12 [symbol] | [5] | Al | 12 | 0.3 | 24 | PES | 40 | 0.1 | — |
| [symbol] 13 [symbol] | [5] | Al | 12 | 0.3 | 24 | PES | 40 | 0.3 | — |

*1: BRILLIANT PIGMENT No.
*2: ASPECT RATIO
“Al” REFERS TO ALUMINUM
“TEOS” REFERS TO TETRAETHOXYSILANE
“PES” REFERS TO POLYESTER

### Production of Electrostatic Charge Image Development Toner and Developer

### (C. 1) Preparation of Dispersion Liquid

(C. 1.1) Preparation of Amorphous Polyester Resin Particle Dispersion Liquid [a1] Monomers other than dimethyl fumarate and trimellitic anhydride among the following monomers [1] and tin dioctylate in an amount of 0.25 parts by mass with respect to a total of 100 parts by mass of the monomers were injected into a reaction vessel comprising a stirrer, a thermometer, a condenser, and a nitrogen gas introduction tube.

### <Monomer [1]>

bisphenol A ethylene oxide 2.2 mol adduct 40 parts by mol
bisphenol A propylene oxide 2.2 mol adduct 60 parts by mol
dimethyl terephthalate 60 parts by mole
dimethyl fumarate 15 parts by mole
dodecenylsuccinic anhydride 20 parts by mole
trimellitic anhydride 5 parts by mole

After reacting for 6 hours at 235° C. under a nitrogen gas airflow, the temperature was lowered to 200° C., the above amounts of dimethyl fumarate and trimellitic anhydride were added, and the mixture was reacted for 1 hour. The temperature was raised to 220° C. over 5 hours, and polymerization was carried out under 10 kPa pressure until the desired molecular weight was achieved, yielding a light yellow transparent amorphous polyester resin [A1]. The amorphous polyester resin [A1] had a weight-average molecular weight of 35000, a number-average molecular weight of 8000, and a glass-transition temperature (Tg) of 56° C.

Next, with respect to 100 parts by mass of the monomer [1], 200 parts by mass of the amorphous polyester resin [A1], 100 parts by mass of methylethyl ketone, 35 parts by mass of isopropyl alcohol, and 7.0 parts by mass of a 10% by mass aqueous ammonium solution were put into a separable flask, and sufficiently mixed and dissolved. Thereafter, while heating at 40° C. and stirring, ion-exchanged water was added dropwise using a liquid feed pump at a liquid feed rate of 8 g/minute, and the dropwise addition was stopped when the liquid feed amount reached 580 parts by mass. Thereafter, the solvent is removed under reduced pressure to obtain an amorphous polyester resin particle dispersion liquid.

A dispersion liquid of amorphous polyester resin particles [a1] was prepared by adding ion-exchanged water to the dispersion liquid of amorphous polyester resin particles to adjust the solids content to 25% by mass. The volume-based average particle diameter of the amorphous polyester resin [A1] in the amorphous polyester resin particle dispersion liquid [a1] was 156 nm.

(C. 1.2) Preparation of Crystalline Polyester Resin Particle Dispersion Liquid [c1]

The following monomer [2] was placed in a reaction vessel equipped with a stirrer, a thermometer, a condenser, and a nitrogen gas inlet tube, and the atmosphere in the reaction vessel was replaced with dry nitrogen gas.

### <Monomer [2]>

dodecanedioic acid 50 parts by mol
1,6-HEXANEDIOL 50 parts by mol

Next, titanium tetrabutoxide (Ti(O-n-Bu) 4) was added in an amount of 0.25 parts by mass relative to 100 parts by mass of the monomer [2]. The mixture was stirred and reacted at 170° C. for 3 hours under a nitrogen gas airflow, the temperature was further increased to 210° C. over 1 hour, the pressure in the reactor was reduced to 3 kPa, and the mixture was stirred and reacted under reduced pressure for 13 hours. Thus, a crystalline polyester resin [C1] was prepared. The crystalline polyester resin [Cl] had a weight average molecular weight of 25000, a number average molecular weight of 8500, and a melting point of 71.8° C.

Next, 200 parts by mass of the crystalline polyester resin [C1], 120 parts by mass of methyl ethyl ketone, and 30 parts by mass of isopropyl alcohol are put into a separable flask and are sufficiently mixed and dissolved at 60° C., and then 8 parts by mass of a 10% by mass aqueous ammonia solution is added dropwise thereto. The heating temperature is decreased to 67° C., and while stirring, ion-exchanged water is added dropwise using a liquid feed pump at a liquid feed rate of 8 g/minute, and when the liquid feed amount reaches 580 parts by mass, the dropwise addition of ion-exchanged water is stopped. Thereafter, the solvent is removed under reduced pressure to obtain a crystalline polyester resin particle dispersion liquid.

Ion-exchanged water is added to the dispersion liquid of crystalline polyester resin particles so as to have a solid content of 25% by weight, thereby preparing a dispersion liquid of crystalline polyester resin particles [c1]. The volume-based average particle diameter of the crystalline polyester resin [C1] in the dispersion liquid of crystalline polyester resin particles [Cl] was 198 nm.

(C. 1.3) Preparation of Release Agent Dispersion Liquid [W1] The following materials [1] are mixed, and in a pressure-ejection homogenizer (Gaulin Homogenizer, manufactured by Gaulin Corporation), the release agent is dissolved at an internal liquid temperature of 120° C., and then the mixture is subjected to dispersion treatment under a dispersion pressure of 5 MPa for 120 minutes and subsequently under 40 MPa for 360 minutes, and cooled to obtain a release agent dispersion liquid.

### <Material [1]>

paraffin wax 270 parts by mass
Anionic surfactant 13.5 parts by mass
(60% by mass of active ingredient, 3% by mass relative to paraffin wax)
Ion-exchanged water: 21.6 parts by mass

Ion-exchanged water is added to the release agent dispersion liquid to adjust the solid content thereof to 20% by mass, preparing a release agent dispersion liquid [W1]. The volume-average particle diameter of the particles in the release agent dispersion liquid [W1] is 215 nm. The paraffin wax is HNP0190 (melting temperature: 85° C.) manufactured by NIPPON SEIRO CO., LTD, and the anionic surfactant is NEOGEN RK manufactured by Dai-ichi Kogyo Seiyaku Co., Ltd.

### (C. 1.4) Preparation of Pigment Dispersion Liquid

### (Preparation of Pigment Dispersion Liquid [1])

The following components [1] were mixed and pre-dispersed for 10 minutes using a homogenizer (ULTRA-TURRAX, manufactured by IKA).

### <Component [1]>

coated brilliant pigment <<1>>40 parts by mass
Pigment Brown 25 (PBr25): 40 parts by mass
Pigment Blue 15:3 (PB15:3): 25 parts by mass
Pigment Violet 23 (PV23): 10 parts by mass
Pigment Yellow 155 (PY155): 25 parts by mass
anionic surfactant 15 parts by mass
ion-exchanged water 400 parts by mass

This was followed by a dispersion treatment at a pressure of 245 MPa for 30 minutes using a high-pressure impact disperser (Ultimizer, manufactured by Sugino Machine Ltd), thereby obtaining an aqueous dispersion liquid of particles containing these components. Ion-exchanged water was added to the aqueous dispersion liquid [1] to adjust the solid content to 15% by mass, thereby preparing a pigment dispersion liquid [1]. The volume-based average particle diameter of the pigment particles in the pigment dispersion liquid [1] was 150 nm. In addition, as the anionic surfactant, NEOGEN RK (“NEOGEN” is a registered trademark of Dai-ichi Kogyo Seiyaku Co., Ltd) manufactured by Dai-ichi Kogyo Seiyaku Co., Ltd. was used.

### (Preparation of Pigment Dispersion Liquids [2] to [13])

Pigment dispersion liquids [2] to [13] were prepared in the same manner as in the preparation of the pigment dispersion liquid [1] except that the type of the brilliant pigment <<1>> in the component [1] was changed as illustrated in Table IV.

### (C. 2) Production of Toner Base Particles

(C. 2.1) Production of Toner Base Particles [1] The following material [2] was placed in a 4-liter reaction vessel equipped with a thermometer, a pH meter, and a stirrer, and a 1.0% by mass aqueous solution of nitric acid was added thereto at a temperature of 25° C. so as to adjust the pH to 3.0.

### <Material [2]>

Dispersion liquid of amorphous polyester resin particles [a1] 1280 parts by mass
Dispersion liquid of crystalline polyester resin particles [c1] 160 parts by mass
release agent dispersion liquid [W1] 200 parts by mass
pigment dispersion liquid [1] 335 parts by mass
anionic surfactant 40 parts by mass
ion-exchanged water 1500 parts by mass

Thereafter, 100 parts by mass of a 2.0% by mass aqueous solution of aluminum sulfate (aggregating agent) is added thereto over 30 minutes while dispersing with 3000 rpm using a homogeniser (manufactured by IKA, Ultra-Turrax T50). After the completion of the dropwise addition, the mixture was stirred for 10 minutes to thoroughly mix the raw materials with the aggregating agent. Thereafter, a stirrer and a mantle heater were installed in the reaction vessel, and the temperature was increased to 40° C. at a temperature increase rate of 0.2° C./min while the number of rotations of the stirrer was adjusted so that the slurry was sufficiently stirred.

After exceeding 40° C., the temperature was raised at a rate of 0.05° C./min, and the particle diameter was measured every 10 minutes using a particle size distribution analyzer (Coulter Multisizer 3 [aperture diameter: 100 μm], manufactured by Beckman Coulter, Inc). When the average particle diameter on a volume basis became 5.9 μm, the temperature was held, and a mixed solution of the following materials [3], which had been mixed in advance, was added over 20 minute.

### <Material [3]>

dispersion liquid of amorphous polyester resin particles [a1] 160 parts by mass
anionic surfactant 15 parts by mass

All of the anionic surfactants added twice are DOWFAX 2A1 (20% aqueous solutions) manufactured by Dow Chemical Company.

Next, after maintaining the temperature at 50° C. for 30 minutes, 8 parts by mass of a 20% by mass aqueous solution of ethylenediaminetetraacetic acid (EDTA) is added to the reactor, and then a 1 mol/L aqueous solution of sodium hydroxide is added to control the pH level of the raw dispersion liquid to 9.0. Thereafter, the temperature was increased to 85° C. at a temperature increase rate of 1° C./min while the pH was adjusted to 9.0 every 5° C., and the temperature was held at 85° C. Thereafter, when the shape factor measured using a particle size analyzer (FPIA 3000, manufactured by Malvern Instruments Ltd) reached 0.970, the mixture was cooled at a temperature lowering rate of 10° C./min to obtain a toner base particle dispersion liquid [1].

Thereafter, the solid content obtained by filtering the toner base particle dispersion liquid [1] was sufficiently washed with ion-exchanged water. Subsequently, the resultant was dried at 40° C. to prepare toner base particles [1]. The obtained toner base particles [1] had a volume-based average particle diameter of 6.0 μm and an average circularity of 0.972 as measured using a particle size analyzer (FPIA 3000, manufactured by Malvern Instruments Ltd).

### (C. 2.2) Preparation of Toner Base Particles [2] to [13]

Toner base particles [2] to [13] are prepared as in the preparation of the toner base particles [1] except that the pigment dispersion liquid [1] in the material [2] is changed as shown in Table IV.

### (C. 3) Production of Carrier [1](C. 3.1) Production of Core Material Particles

Each raw material [1] was weighed so as to have the following amount ratio, mixed with water, and then pulverized with a wet media mill for 5 hours to obtain a slurry.

### <Raw Material [1]>

Raw material

| | |
|---|---|
| MnO | 35.0 Mol % |
| MgO | 14.5 Mol % |
| Fe₂O₃ | 50.0% |
| SrO | 0.5 Mol % |

The obtained slurry was dried with a spray dryer to obtain true spherical particles. The particles are subjected to particle size adjustment, the mixture was heated at 950° C. for 2 hours and calcinated in a rotary kiln.

The mixture was ground in a dry ball mill using stainless steel beads having a diameter of 0.3 cm for 1 hour. After that, 0.8 parts by mass of polyvinyl alcohol (PVA) as a colorant was added to the material [1] when the total amount of the material [1] was 100 parts by mass, and the solid contents of the material were further added with water and a polycarboxylic acid-based dispersing agent, followed by pulverization for 30 hours using zirconia beads having diameters of 0.5 cm.

The obtained powder was granulated and dried by a spray dryer, and held in an electric furnace at a temperature of 1050° C. for 15 hours to perform main firing. The powder after the firing was crushed and further classified to adjust the particle size, and then a low magnetic force product was fractionated by magnetic separation to obtain core material particles. The volume-average particle diameter of the core material particles was 30 μm.

The volume average particle diameter of the core material particles is a value obtained by performing measurement according to a wet method using a laser diffraction particle size distribution measurement device (HEROSKA, manufactured by Nippon Laser Co., Ltd). Specifically, first, the optical system at the focal position 200 mm was selected, and the measurement time was set to 5 seconds.

Next, the core material particle for measurement is added to a 0.2% by mass aqueous solution of sodium dodecyl sulfate and dispersed for 3 minutes using an ultrasonic cleaner (US-1, manufactured by Asone Corporation) to prepare a sample dispersion liquid for measurement, and several drops of this are supplied to the laser diffraction particle size distribution measuring apparatus, and the measurement is started at the time when a sample concentration gauge reaches a measurable region. Regarding the obtained particle size distribution, a cumulative distribution was created from the small diameter side with respect to the particle size range (channel), and the particle diameter (D₅₀) at which the Cumulative Percentage Reached 50% was Taken as the Volume Average Particle Diameter.

### (C. 3.2) Preparation of Coating Resin for Core Material Particle

Into an aqueous solution of 0.3% by mass of sodium benzenesulfonate, cyclohexyl methacrylate and methyl methacrylate were added in amounts such that the mass ratio (copolymerization ratio) became 70:30, and potassium persulfate was added in an amount corresponding to 0.5% by mass of the total amount of monomers to perform emulsion polymerization. Thereafter, it was dried by spray drying to produce a coating resin. The weight-average molecular weight of the coating resin was 500000.

### (C. 3.3) Coating of Core Material Particles

Into a high-speed stirring mixer equipped with a horizontal stirring blade, 100 parts by mass of the prepared core material particles and 4.5 parts by mass of the prepared coating resins were charged, and mixed and stirred at 22° C. for 15 minutes under the condition that the peripheral speed of the horizontal rotary blade was 8 m/sec. The resulting mixture is mixed at 120° C. for 50 minutes to cause a mechanical impact (mechanochemical method) to coat the surface of the core particle with the coating resin, and then cooled to room temperature to produce carrier [1].

### (C. 4) Production of Developers 1 to 19

### (C. 4.1) Production of Developer 1

### (Addition of External Additive)

The names, main components, particle diameters, and manufacturers of the external additives added in the preparation of developers 1 to 19 are shown in Table III. To 100 parts by mass of the toner base particles [1], 1% by mass of titania “TAF-520” (number-average primary particle diameter=200 nm manufactured by Fuji Titanium Industry Co., Ltd) that was an external additive [1] described in Table III was added, mixed using a Henschel mixer, and added.

TABLE III
EXTERNAL ADDITIVE

| | | | PARTICLE | |
|---|---|---|---|---|
| | | | DIAMETER | |
| No. | NAME | MAIN COMPONENT | [nm] | MANUFACTURER |
| [1] | TAF520 | TITANIUM DIOXIDE | 200 | FUJI TITANIUM INDUSTRY |
| [2] | H1303 | SILICON DIOXIDE | 12 | CLARIANT |
| [3] | R805 | SILICON DIOXIDE | 12 | AEROSIL |
| [4] | NAX50 | SILICON DIOXIDE | 30 | AEROSIL |
| [5] | X24 | SILICON DIOXIDE | 80 | SHIN - ETSU CHEMICAL |

(Mixture with Carrier)

Thereafter, the resultant was mixed with the carrier [1] so that the toner concentration was 9% by mass, and the mixture was mixed at 25° C. for 30 minutes by using a V-type mixer (manufactured by Tokuju Corporation), to thereby produce a developer 1 as a two-component developer. As the carrier [1], a ferrite carrier having a volume average particle diameter of 60 μm was used.

External Additive [1] For the measurement of the number-average particle size of the particles, a scanning electron microscopy (SEM) (manufactured by JEOL Ltd., JEM-7401F) was used. A SEM photograph magnified 50,000-fold was taken with a scanner, and the external additive particles in the SEM photograph image were subjected to binarization processing with an image processing and analyzing apparatus (LUZEX AP, manufactured by Nireco Corporation), and the Feret's diameters in the horizontal direction of 100 external additive particles were calculated and determined.

### (C. 4.2) Preparation of Developers 2 to 16, 18, and 19

Developers 2 to 16, 18, and 19 were produced in the same manner as the developer 1, except that the type of the toner base particle was changed from the toner base particle [1] to those listed in Table IV.

### (C. 4.3) Production of Developer 17

A developer 15 is prepared as with the developer 1 except that the mono-component developer is prepared without mixing with the carrier.

TABLE IV
DEVELOPER

| | TONER | | | | | | | | | | |
|---|---|---|---|---|---|---|---|---|---|---|---|
| | | DISPERSION LIQUID | | | | | | | | | |
| | | | CRYS- | | | | | | | | |
| | | AMORPHOUS | TALLINE | RELEASE | PIGMENT | | EXTERNAL ADDITIVE | | | | |
| | BASE | RESIN | RESIN | AGENT | DISPERSION | | | | AMOUNT | CARRIER | |
| | PAR- | PARTICLE | PARTICLE | DIS- | LIQUID | | | PARTICLE | [PARTS | PAR- | |
| | TICLE | DISPERSION | DISPERSION | PERSION | | BRILLIANT | | DIAMETER | BY | TICLE | |
| NO. | No. | LIQUID | LIQUID | LIQUID | No. | PIGMENT | No. | [nm] | MASS] | No. | REMARKS |
| 1 | [1] | [a1] | [c1] | [W1] | [1] | [symbol] 1 [symbol] | [1] | 200 | 1.0 | [1] | *1 |
| 2 | [2] | [a1] | [c1] | [W1] | [2] | [symbol] 2 [symbol] | [1] | 200 | 1.0 | [1] | *1 |
| 3 | [3] | [a1] | [c1] | [W1] | [3] | [symbol] 3 [symbol] | [1] | 200 | 1.0 | [1] | *1 |
| 4 | [4] | [a1] | [c1] | [W1] | [4] | [symbol] 4 [symbol] | [2] | 12 | 1.0 | [1] | *1 |
| 5 | [4] | [a1] | [c1] | [W1] | [4] | [symbol] 4 [symbol] | [3] | 12 | 1.0 | [1] | *1 |
| 6 | [4] | [a1] | [c1] | [W1] | [4] | [symbol] 4 [symbol] | [4] | 30 | 1.0 | [1] | *1 |
| 7 | [4] | [a1] | [c1] | [W1] | [4] | [symbol] 4 [symbol] | [5] | 80 | 1.0 | [1] | *1 |
| 8 | [4] | [a1] | [c1] | [W1] | [4] | [symbol] 4 [symbol] | [1] | 200 | 0.3 | [1] | *1 |
| 9 | [4] | [a1] | [c1] | [W1] | [4] | [symbol] 4 [symbol] | [1] | 200 | 0.1 | [1] | *1 |
| 10 | [5] | [a1] | [c1] | [W1] | [5] | [symbol] 5 [symbol] | [2] | 12 | 1.0 | [1] | *1 |
| 11 | [6] | [a1] | [c1] | [W1] | [6] | [symbol] 6 [symbol] | [3] | 12 | 1.0 | [1] | *1 |
| 12 | [7] | [a1] | [c1] | [W1] | [7] | [symbol] 7 [symbol] | [1] | 200 | 1.0 | [1] | *1 |
| 13 | [8] | [a1] | [c1] | [W1] | [8] | [symbol] 8 [symbol] | [1] | 200 | 1.0 | [1] | *1 |
| 14 | [9] | [a1] | [c1] | [W1] | [9] | [symbol] 9 [symbol] | [1] | 200 | 1.0 | [1] | *1 |
| 15 | [10] | [a1] | [c1] | [W1] | [10] | [symbol] 10 [symbol] | [1] | 200 | 1.0 | [1] | *1 |
| 16 | [11] | [a1] | [c1] | [W1] | [11] | [symbol] 11 [symbol] | [1] | 200 | 1.0 | [1] | *1 |
| 17 | [1] | [a1] | [c1] | [W1] | [1] | [symbol] 1 [symbol] | [1] | 200 | 1.0 | — | *1 |
| 18 | [12] | [a1] | [c1] | [W1] | [12] | [symbol] 12 [symbol] | [1] | 200 | 1.0 | [1] | *2 |
| 19 | [13] | [a1] | [c1] | [W1] | [13] | [symbol] 13 [symbol] | [1] | 200 | 1.0 | [1] | *2 |

*1: PRESENT INVENTION
*2: COMPARATIVE EXAMPLE

### D. Image Quality Evaluation

### (D. 1) Preparation of Evaluation Device

A commercially available color multifunction peripheral “bizhub PRESS C7lcf (manufactured by Konica Minolta, Inc)” was modified so as to be able to form an image on continuous sheet and freely set the amount of toner adhesion.

In order to reproduce the condition in which heat is taken away by paper, the paper had been left to stand for 10 hours or longer in a room at a room temperature of 5° C. was prepared in advance.

The printing machine was allowed to stand at an indoor temperature of 15° C. for 10 hours or more.

Thus, the temperature is lower by 5 to 10° C. than the condition of storing at a normal room temperature of 20° C. and performing printing at a normal sheet interval, and the fixing member is in a state of being more vulnerable than under normal conditions. The output device used in the present application does not have a function such as heating when the temperature of the fixing member is low. Each of the developers 1 to 19 produced as described above is set in the evaluation apparatus described above, and thus an image forming apparatus for evaluation is obtained.

### (D. 2) Evaluation Method

Using the above-described image forming apparatus, a rectangular figure having an adhesion amount of 4 g/m² and a width of 400 mm×a length of 277 mm (A3) at a printing rate of 80% was printed 100,000 times on normal roll sheet (width of 420 mm×length of 150 m) manufactured by Konica Minolta, Inc. at an image interval 20 mm and a fixing roller surface temperature of 180° C. Thereafter, image defects (streak unevenness) derived from scratches on the surfaces of the fixing members on the fixed images were evaluated by visually observing how many streak unevenness occurred in the rectangular shape having a width of 400 mm×a length of 277 mm by six specialists in image inspection.

In the evaluation, superiority or inferiority of quality was evaluated in five stages according to the following evaluation criteria, and the highest evaluation was defined as 5 and the lowest evaluation was defined as 1. In addition, the final evaluation value was an average value of six persons. Table V shows the result of the evaluation.

### (Evaluation Criterion)

5: No streak unevenness was observed.
4: Occurrence of one to three fine streak unevenness is recognized, but there is no problem.
3: 4 to 6 occurrences of fine streak unevenness were observed, but were in a practically acceptable range.
2: The occurrence of fine streak unevenness was 7 or more.
1: Clear streak unevenness is observed, and the quality is practically problematic.

TABLE V

| | DEVELOPER | | | | | | |
|---|---|---|---|---|---|---|---|
| | | | EXTERNAL ADDITIVE | | | | |
| IMAGE | | | | | AMOUNT | | |
| FORMING | | BRILLIANT | | PARTICLE | [PARTS | IMAGE | |
| SYSTEM | | PIGMENT | | DIAMETER | BY | QUALITY | |
| No. | No. | No. | No. | [nm] | MASS] | EVALUATION | REMARKS |
| 1 | 1 | [symbol] 1 [symbol] | [1] | 200 | 1.0 | 3 | PRESENT INVENTION |
| 2 | 2 | [symbol] 2 [symbol] | [1] | 200 | 1.0 | 4 | PRESENT INVENTION |
| 3 | 3 | [symbol] 3 [symbol] | [1] | 200 | 1.0 | 4 | PRESENT INVENTION |
| 4 | 4 | [symbol] 4 [symbol] | [2] | 12 | 1.0 | 3 | PRESENT INVENTION |
| 5 | 5 | [symbol] 4 [symbol] | [3] | 12 | 1.0 | 3 | PRESENT INVENTION |
| 6 | 6 | [symbol] 4 [symbol] | [4] | 30 | 1.0 | 3 | PRESENT INVENTION |
| 7 | 7 | [symbol] 4 [symbol] | [5] | 80 | 1.0 | 3 | PRESENT INVENTION |
| 8 | 8 | [symbol] 4 [symbol] | [1] | 200 | 0.3 | 5 | PRESENT INVENTION |
| 9 | 9 | [symbol] 4 [symbol] | [1] | 200 | 0.1 | 4 | PRESENT INVENTION |
| 10 | 10 | [symbol] 5 [symbol] | [2] | 12 | 0.1 | 3 | PRESENT INVENTION |
| 11 | 11 | [symbol] 6 [symbol] | [3] | 12 | 0.1 | 3 | PRESENT INVENTION |
| 12 | 12 | [symbol] 7 [symbol] | [1] | 200 | 1.0 | 4 | PRESENT INVENTION |
| 13 | 13 | [symbol] 8 [symbol] | [1] | 200 | 1.0 | 4 | PRESENT INVENTION |
| 14 | 14 | [symbol] 9 [symbol] | [1] | 200 | 1.0 | 4 | PRESENT INVENTION |
| 15 | 15 | [symbol] 10 [symbol] | [1] | 200 | 1.0 | 1 | PRESENT INVENTION |
| 16 | 16 | [symbol] 11 [symbol] | [1] | 200 | 1.0 | 2 | PRESENT INVENTION |
| 17 | 17 | [symbol] 1 [symbol] | [1] | 200 | 1.0 | 3 | PRESENT INVENTION |
| 18 | 18 | [symbol] 12 [symbol] | [1] | 200 | 1.0 | 1 | COMPARATIVE EXAMPLE |
| 19 | 19 | [symbol] 13 [symbol] | [1] | 200 | 1.0 | 1 | COMPARATIVE EXAMPLE |

### E. Summary

From the results in Table V, it can be seen that Examples are superior to Comparative Examples in terms of image quality evaluation.

According to the above-described section of one embodiment of the present invention, it is possible to provide an image forming system and an image forming method capable of preventing image defects such as streak unevenness by reducing scratches on a fixing member during image formation.

The expression mechanism or action mechanism of the effect of one embodiment of the present invention is not clear, but it is presumed as follows.

In recent years, there has been an increasing demand for printing in a horizontally long dimension, and in order to meet such a demand, there has been an electrophotographic printing apparatus capable of using continuous sheet. In the case of printing on ordinary cut sheet, the temperature of the fixing member can be raised between the sheets of paper because there is a space between the sheets of paper on the fixing member at the lime of fixing.

However, in the case of printing on continuous sheet, since there is no sheet interval, the temperature of the fixing member (fixing temperature) does not rise to a set temperature and becomes low. Further, since the temperature of the sheet conveying member decreases and the sheet conveying member becomes hard, the continuous sheet is easily damaged. On the other hand, the electrostatic charge image development toner (hereinafter, also simply referred to as “toner”) used in the image forming system for forming an image on continuous sheet according to one embodiment of the present invention contains a binder resin and a brilliant pigment having a coating layer containing an inorganic element.

Here, an end portion of the brilliant pigment having a long plate-like shape (hereinafter, also simply referred to as a “scaly shape”) has a sharp corner in many cases. Since the binder resin contained in the ordinary toner is soft, for example, the brilliant pigment is an aluminum pigment, the end of the aluminum pigment may penetrate through the binder resin. The penetrated pigment scratches the fixing member that has become hard due to a low temperature.

That is, as described above, since the temperature of the fixing member becomes low in the case of printing on continuous sheet, it is presumed that the fixing member is damaged in the case of fixing on continuous sheet. This damage causes an image defect.

In contrast, the brilliant pigment included in the electrostatic charge image development toner used in the image forming system for forming an image on continuous sheet of one embodiment of the present invention is covered with a coating layer containing an inorganic element. Therefore, the end portion of the brilliant pigment is covered with the coating layer, and the brilliant pigment does not easily penetrate the binder resin, and even when the brilliant pigment penetrates the binder resin, the fixing member is not damaged since the sharp corner is covered.

Therefore, it is presumed that even in the case of continuous sheet, damage to the fixing member can be reduced, and image defects such as streak unevenness during image formation can be prevented.

Although embodiments of the present invention have been described and illustrated in detail, the disclosed embodiments are made for purposes of illustration and example only and not limitation. The scope of the present invention should be interpreted by terms of the appended claims.

1. An image forming system that forms an image on a continuous sheet using an electrostatic charge image development toner, wherein
the electrostatic charge image development toner includes a toner base particle including a binder resin and a brilliant pigment having a coating layer containing an inorganic element.

2. The image forming system according to claim 1, wherein a thickness of the coating layer is in a range of 0.01 to 0.50 μm.

3. The image forming system according to claim 1, wherein a particle diameter of an external additive added to the toner base particle is in a range of 20 to 300 μm.

4. The image forming system according to claim 1, wherein an aspect ratio of the brilliant pigment is in a range of 3 to 100.

5. The image forming system according to claim 1, wherein the brilliant pigment is aluminum.

6. The image forming system according to claim 1, wherein the coating layer contains a silicon-containing compound.

7. The image forming system according to claim 1, comprising an LED light source as an exposure section.

8. An image forming method for forming an image on a continuous sheet using an electrostatic charge image development toner, wherein
the electrostatic charge image development toner includes a toner base particle including a binder resin and a brilliant pigment having a coating layer containing an inorganic element.

9. The image forming method according to claim 8, wherein the coating layer has a thickness in a range of 0.01 to 0.50 μm.

10. The image forming method according to claim 8, wherein a particle diameter of an external additive added to the toner base particle is in a range of 20 to 300 μm.

11. The image forming method according to claim 8, wherein an aspect ratio of the brilliant pigment is in a range of 3 to 100.

12. The image forming method according to claim 8, wherein the brilliant pigment is aluminum.

13. The image forming method according to claim 8, wherein the coating layer contains a silicon-containing compound.

14. The image forming method according to claim 8, wherein an LED light source is provided as an exposure section.
